(19) United States
(12) Patent Application Publication
(10) Pub. No.: US 2023/0390594 A1
(43) Pub. Date: Dec. 7, 2023

(54) A Bi-Valve Air Filter Mask

(71) Applicant: Liberty Health Technologies, Inc., Santa Barbara, CA (US)

(72) Inventors: Robert Anthony Salazar, Big Bear Lake, CA (US); Chris Outwater, Carpinteria, CA (US)

(21) Appl. No.: 18/249,392

(22) PCT Filed: Oct. 18, 2021
(86) PCT No.: PCT/US2021/055373

§ 371 Date: Apr. 18, 2023

Related U.S. Application Data
(60) Provisional application No. 63/093,655, filed on Oct. 19, 2020.

(51) Int. Cl. A62B 18/10; A62B 18/02

(52) U.S. Cl. CPC A62B 18/10; A62B 18/025

(57) ABSTRACT

A multi-chambered mask separately filters inhaled and exhaled air. When a person exhales, exhaled air is expelled from a core mask to a first outer filter chamber using a first one-way check valve located between the core mask and the first filter chamber. The core mask creates a core chamber between the core mask and the person's face. The first filter chamber encloses a first volume of air and filters air that passes from the first filter chamber through the first filter chamber's wall. When a person inhales, air is drawn from a second outer filter chamber to the core mask using a second one-way check valve located between the core mask and the second filter chamber. The second filter chamber encloses a second volume of air and filters air that passes into the second filter chamber through the second filter chamber's wall.

### RELATED APPLICATIONS

This application claims the benefit of U.S. Provisional patent application Ser. No. 63/093,655, filed on Oct. 19, 2020, the content of which is incorporated by reference herein in its entirety.

### INTRODUCTION

### Field of the Invention

The teachings herein relate to respirators, medical face coverings, and masks. More specifically, various embodiments relate to masks that limit the mixing of inhaled and exhaled air within the mask and separately filter inhaled and exhaled air using more than one filtering chamber.

### DESCRIPTION OF THE PRIOR ART

In light of various respiratory diseases, including COVID 19, the CDC has issued guidance for all people to wear masks and maintain social distancing under certain circumstances. In addition, many state and local governments have mandated wearing masks. Also, various companies such as restaurants and airlines have mandated wearing air filter masks.

Therefore, people who choose to follow the recommendations and adhere to the law will choose to wear face masks to protect themselves and others. There are over 50 million people in the United States with compromised pulmonary conditions.

This ranges from asthma to chronic obstructive pulmonary disease (COPD) and pulmonary fibrosis. These people need to wear masks to protect themselves from respiratory illnesses of all sorts and they also need to inhale as much oxygen as possible with each breath.

The problem is that many mask wearers, after a short period of time wearing a properly fitted N95 style mask, feel as if they are suffocating and cannot get enough fresh air. This is because the mask wearer has to actively pull air through the mask's filter material into his or her nose and mouth. More importantly, the wearer's warm, exhaled air is momentarily trapped in front of the wearer's nose and mouth. Because this stale, exhaled air is trapped in the mask it becomes part of the first air that is being drawn into the mask before mixing with fresh air from the ambient air, thus lowering the amount of fresh air and oxygen that can be inhaled into the lungs.

As a result, additional apparatus and methods are needed to reduce the exhaled air trapped in a mask with each exhale and increase the amount of fresh air and oxygen brought into the mask with each inhale.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is an exemplary cutaway diagram of a bi-valve mask that includes separate breathing chambers to reduce the mixing of inhaled and exhaled air, in accordance with various embodiments.

FIG. 2 is an exemplary front view diagram showing how one exterior air filter chamber of a bi-valve mask can be located on the right side of the mouth, in accordance with various embodiments.

FIG. 3 is an exemplary side view diagram showing how one exterior air filter chamber of a bi-valve mask can be located on the right side of the mouth, in accordance with various embodiments.

FIG. 4 is an exemplary top view diagram showing how one exterior air filter chamber of a bi-valve mask can be located on the right side of the mouth, in accordance with various embodiments.

FIG. 5 is an exemplary flowchart showing a method for separately filtering inhaled and exhaled air using a mask, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

As described above, many mask wearers, after a short period of time wearing a properly fitted N95 style mask, feel as if they are suffocating and cannot get enough fresh air. This is because the mask wearer has to actively pull air through the mask's filter material into his or her nose and mouth. More importantly, the wearer's warm, exhaled air is momentarily trapped in front of the wearer's nose and mouth. Because this stale, exhaled air is trapped in the mask it becomes part of the first air that is being drawn into the mask before mixing with fresh air from the ambient air, thus lowering the amount of fresh air and oxygen that can be inhaled into the lungs.

As a result, additional apparatus and methods are needed to reduce the exhaled air trapped in a mask with each exhale and increase the amount of fresh air and oxygen brought into the mask with each inhale.

The intent of various embodiments is to have the most amount of fresh air come into the mask through the filtering material and have the least amount of exhaled air mixing with the incoming fresh air. In various embodiments, this is achieved by using separate breathing chambers to reduce the mixing of inhaled and exhaled air.

High surface area filters improve breathability by decreasing airflow resistance, but have the unfortunate effect of increasing the volume of exhaled air that is rebreathed in current N95 mask embodiments. By incorporating a set of one way valves and having separate filters for inhalation and exhalation, various embodiments can maximize filter surface area, and thus breathability, independently of minimizing the volume of exhaled air that is rebreathed, further increasing breathability.

### Bi-Valve Air Filter Mask

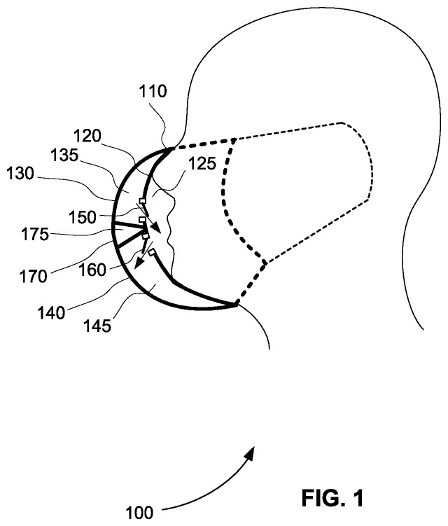

FIG. 1 is an exemplary cutaway diagram 100 of a bi-valve mask that includes separate breathing chambers to reduce the mixing of inhaled and exhaled air, in accordance with various embodiments. Bi-valve mask 110 includes a central, core mask 120 that covers the nose and mouth and creates a core chamber 125. This central, core chamber 125 has a low profile and a low volume. Low volume is desired because it is this volume of air that will allow any mixing of exhaled and inhaled air inside the core chamber. In other words, as long as the nose and mouth are sealed and covered, the volume of air in core breathing chamber 125 can be minimized. The volume of air in core chamber 125 is far less than a standard N95 mask. Note that the core chamber material can be made out of standard N95 material or a more solid material, such as plastic or coated paper that is air impermeable.

Core mask 120 made be manufactured or molded to the exact contours of each mask wearer's face. In this way, a better seal can be made between core mask 120 and the mask wearer's face. A good airtight seal ensures that the bi-valve mask is providing protection.

Besides low volume core chamber 125, the other important features are the two exterior air chambers 135 and 145 that are attached to core breathing chamber 125. One-way check valves 150 and 160 connect core chamber 125 to air chambers 135 and 145, respectively. Note that check valves 150 and 160 allow air to flow through the valve in only one direction, either in only or out only, but not both directions. Check valves 150 and 160 are both shown as being open. However, only one of check valves 150 and 160 is open at any one time.

In the embodiment shown in FIG. 1, there are two exterior air filter chambers 135 and 145, chamber 135 being above the mouth area and chamber 145 being below the mouth area. Either one of the chambers could be the air inlet chamber as long as the other chamber is the air outlet chamber. It is preferable, however, to have chamber 135 be the air inlet chamber and chamber 145 be the air outlet chamber to channel warm exhaled air below the mouth to prevent fogging eyeglasses.

In an alternative embodiment, there are two exterior air filter chambers, one on each side of the mouth. Either one of the chambers could be the air Inlet chamber as long as the other chamber is the air outlet chamber. In this embodiment, it does not matter whether the air inlet chamber is on the left or right side of the mouth. If the air inlet is on the left side, then the air outlet would be on the right side and vice versa.

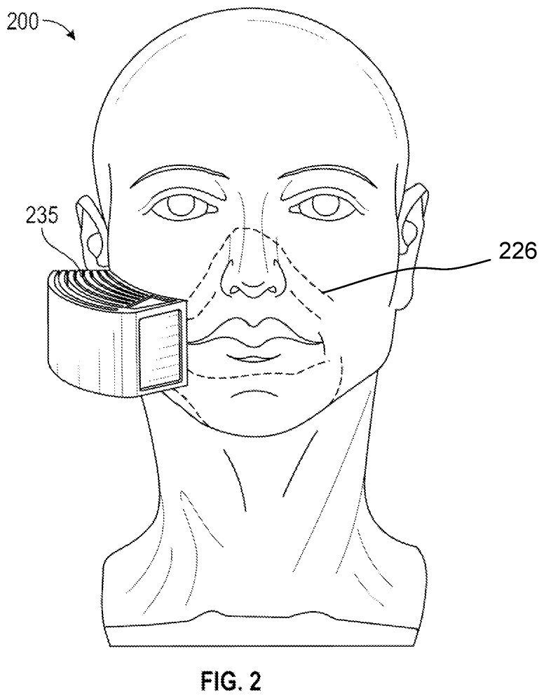

FIG. 2 is an exemplary front view diagram 200 showing how one exterior air filter chamber of a bi-valve mask can be located on the right side of the mouth, in accordance with various embodiments. In FIG. 2, exterior air filter chamber 235 is located on the right side of the mouth. The top of air filter chamber 235 is shown as being open to allow the multiple layers of filters in air filter chamber 235 to be seen. In operation, however, the top of air filter chamber 235 and all sides of air filter chamber 235 are enclosed to trap particles in air filter chamber 235.

As described in reference to FIG. 1, air moves into or out of air filter chamber 235 through a check valve (not shown) connected to a core mask (not shown) covering the nose and mouth. Lines 226 depict areas of contact on a person's face for the core mask. FIG. 2 only shows one exterior air filter chamber 235. A second air filter chamber (not shown) is positioned on the left side of the mouth, for example.

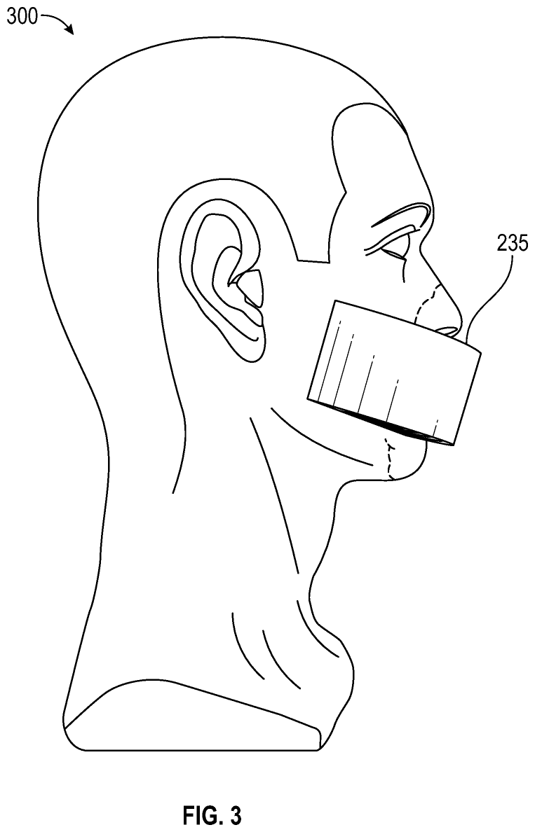

FIG. 3 is an exemplary side view diagram 300 showing how one exterior air filter chamber of a bi-valve mask can be located on the right side of the mouth, in accordance with various embodiments. In FIG. 3, exterior air filter chamber 235 is located on the right side of the mouth.

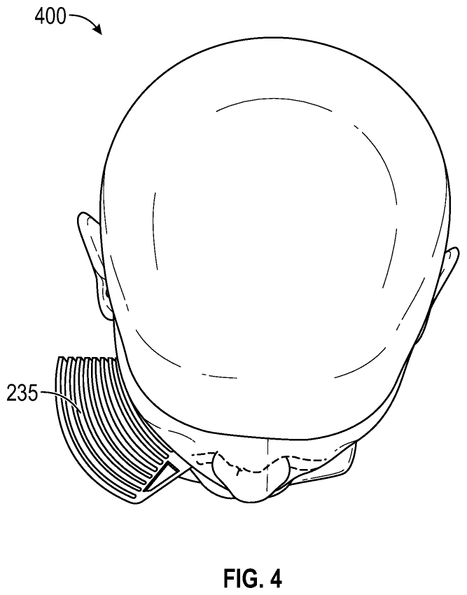

FIG. 4 is an exemplary top view diagram 300 showing how one exterior air filter chamber of a bi-valve mask can be located on the right side of the mouth, in accordance with various embodiments. In FIG. 4, exterior air filter chamber 235 is located on the right side of the mouth. The top and back of air filter chamber 235 are shown as being open to allow the multiple layers of filters in air filter chamber 235 to be seen. These multiple layers of filters in air filter chamber 235 are easily seen in FIG. 4. In operation, however, the top and back of air filter chamber 235 and all sides of air filter chamber 235 are enclosed to trap particles in air filter chamber 235.

Returning to FIG. 1, the following criteria serve to define the preferred bi-valve mask embodiments. There are at least two check valves 150 and 160 attached to core chamber 125. Said two check valves can be located in close proximity to each other in the core chamber. Said two check valves can be oriented either vertically, one on top of the other, or horizontally, one beside the other. There is no clear advantage to other angles of orientation, such as 45 degrees offset from each other.

Although two check valves 150 and 160 can be close to each other, there should be some space 175 between chambers 135 and 145 so that the air inlet chamber is not pulling in exhaled air from the air outlet chamber. If the chambers are on the right and left of the mouth, then there is no issue. If the two chambers are above and below each other, then more care needs to be taken that any exhaled air from the air outlet filter chamber cannot enter the air inlet filter chamber. In various embodiments, space 175 is a third chamber into which air cannot flow to or from either chamber 135 and 145. This closed space 175 or chamber also maintains a constant shape of the outside of mask 110 improving its appearance. In various embodiments, space 175 can also be a solid volume.

Check valves 150 and 160 are preferably close to the nose and mouth, ideally directly in front of the nose and mouth. This minimizes the volume of air in core chamber 125 where any exhaled air can mix with incoming fresh air to be inhaled.

If oriented vertically, as shown in FIG. 2, one on top of the other, then in normal conditions lower check valve 160 is the air outlet check valve for exhaled air into air outlet chamber 145. Again, this lower position towards the chin area helps prevent warm exhaled air from rising and fogging reading glasses during exhaling.

In one embodiment core mask 120 is made of a resilient plastic and can be washed and reused. Core mask 120 includes check valves 150 and 160.

In various embodiments, outer chamber 135 is formed by placing outer mask 130 over a portion of core mask 120 that includes check valve 150, and outer chamber 145 is formed by placing outer mask 140 over a portion of core mask 120 that includes check valve 160. In various embodiments, outer mask 130 creating chamber 135 and outer mask 140 creating chamber 145 are replaceable and made of a disposable filter material.

In another embodiment, each of the two replaceable exterior air chambers 135 and 145 has its own one-way check valve and attaches to core mask 120. In this embodiment, core mask 120 has an attachment point for each exterior air chamber, but core chamber mask 120 would not have its own, permanent check valves. In this case, the mask wearer would need to be sure to attach one inlet air chamber and one outlet air chamber, that is, one of each to chamber mask 120. Otherwise, the wearer could not breathe normally through chamber mask 120.

In one embodiment, check valves 150 and 160 can be oriented so that they do not block the mouth in case the wearer chooses to speak through mask 110. In other words, the two check valves could be above and below the mouth or on either side of the mouth.

As mentioned, the core mask 120 is one unit that covers the nose and mouth forming chamber 125 between core mask 120 and the wearer's face. Core mask creates low profile and low volume chamber 125. This minimizes the volume of exhaled air mixing with fresh, incoming air in chamber 125.

In one embodiment, the air inlet filter chamber and the air outlet filter chamber are symmetrical and cylindrical in shape. Each can be composed of N95 or other approved filter material.

Mask 110 does not have an unfiltered exhale vent, which in many cases is unacceptable. To be clear, the exhaled air is filtered as it escapes or is pushed through the filter material of outer mask 140 and out into the ambient air.

It is important to note that the intention is to have as little air resistance as possible in either the inhalation or exhalation process. The intention is also to have as little stress as possible on the lungs as they inhale and exhale and to also make the inhaled air as fresh and oxygen-rich as possible.

Bi-Valve mask 110 allows the mask wearer to breathe normally through their mouth, their nose, or both. It should be noted that the area of an N95 mask down by the chin and along the jawline is typically not the source of fresh air to be inhaled. The fresh air to be inhaled comes predominantly from the upper cheek and general cheek area of the mask, including the general nose and mouth area.

For this reason, air outlet chamber 145 of bi-valve mask 110 predominantly covers the chin and jawline. This offers the least restriction to draw fresh ambient air through air inlet chamber 135 that would be closer to the upper cheeks and bridge of the nose.

### Bi-Valve Mask

Again in reference to FIG. 1, bi-valve mask 110 is a mask for separately filtering inhaled and exhaled air, in accordance with various embodiments. Bi-valve mask 110 includes core mask 120, a first outer filter chamber 135, a second outer filter chamber 145, a first one-way check valve 150, and a second one-way check valve 160.

Core mask 120 covers the nose and mouth of a person's face and creates an airtight core chamber between core mask 120 and the person's face. First outer filter chamber 145 encloses a first volume of air and filters any air that passes from first outer filter chamber 145 through a wall of first outer filter chamber 145. Second outer filter chamber 135 encloses a second volume of air and filters any air that passes into second outer filter chamber 135 through a wall of second outer filter chamber 135.

First one-way check valve 160 is located between core mask 120 and first outer filter chamber. First one-way check valve 160 opens with an exhale of the person and conveys exhaled air from core chamber 125 to first outer filter chamber 145 with the exhale. Second one-way check valve 150 is located between core mask 120 and second outer filter chamber 135. Second one-way check valve 150 opens with an inhale of the person and conveys air from second outer filter chamber 135 to core chamber 125 with the inhale.

In various embodiments, first one-way check valve 160 and second one-way check valve 150 are part of core mask 120.

In various embodiments, first one-way check valve 160 and second one-way check valve 150 are positioned vertically on the core mask and second one-way check valve 150 is located above first one-way check valve 160.

In various embodiments, first one-way check valve 160 and second one-way check valve 150 are positioned horizontally on core mask 120.

In various embodiments, first outer mask 140 covers a portion of core mask 120, includes first one-way check valve 160, and forms first outer filter chamber 145 between core mask 120 and first outer mask 140. Second outer mask 130 covers a portion of core mask 120, includes second one-way check valve 150, and forms second outer filter chamber 135 between core mask 120 and second outer mask 130.

In various embodiments, bi-valve mask 110 further includes space 175 between first outer mask 140 and second outer mask 130.

In various embodiments, bi-valve mask 110 further includes covering 170 for space 175 that forms a third chamber between first outer mask 140 and second outer mask 130 in order to maintain a constant shape for bi-valve mask 110. The walls that form the third chamber or space 175 are airtight to prevent airflow through the third chamber.

In various embodiments, first one-way check valve 160 is part of first outer filter chamber 145 and second one-way check valve 150 is part of second outer filter chamber 135.

In various embodiments, first one-way check valve 160 of first outer filter chamber 145 is used to connect first outer filter chamber 145 to core mask 110. Second one-way check valve 150 of second outer filter chamber 135 is used to connect second outer filter chamber 135 to core mask 110.

In various embodiments, first one-way check valve 160 closes with an inhale of the person and second one-way check valve 150 closes with an exhale of the person.

### Method for Separately Filtering Inhaled and Exhaled Air

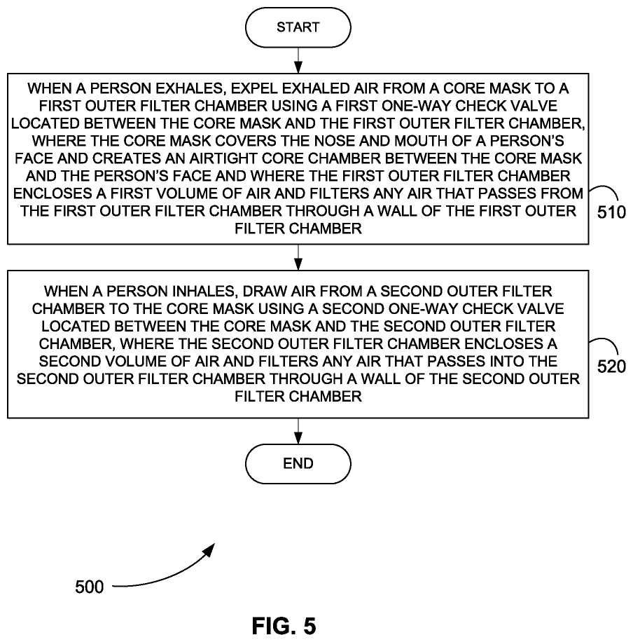

FIG. 5 is an exemplary flowchart showing a method 500 for separately filtering inhaled and exhaled air using a mask, in accordance with various embodiments.

In step 510 of method 500, when a person exhales, exhaled air is expelled from a core mask to a first outer filter chamber using a first one-way check valve located between the core mask and the first outer filter chamber. The core mask covers the nose and mouth of a person's face and creates an airtight core chamber between the core mask and the person's face. The first outer filter chamber encloses a first volume of air and filters any air that passes from the first outer filter chamber through a wall of the first outer filter chamber.

In step 520, when a person inhales, air is drawn from a second outer filter chamber to the core mask using a second one-way check valve located between the core mask and the second outer filter chamber. The second outer filter chamber encloses a second volume of air and filters any air that passes into the second outer filter chamber through a wall of the second outer filter chamber.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A mask for separately filtering inhaled and exhaled air, comprising:
a core mask for covering the nose and mouth of a person's face that creates an airtight core chamber between the core mask and the person's face;
a first outer filter chamber enclosing a first volume of air that filters any air that passes from the first outer filter chamber through a wall of the first outer filter chamber.
a second outer filter chamber enclosing a second volume of air that filters any air that passes into the second outer filter chamber through a wall of the second outer filter chamber;
a first one-way check valve located between the core mask and the first outer filter chamber that opens with an exhale of the person and conveys exhaled air from the core chamber to the first outer filter chamber with the exhale; and
a second one-way check valve located between the core mask and the second outer filter chamber that opens with an inhale of the person and conveys air from the second outer filter chamber to the core chamber with the inhale.

2. The mask of claim 1, wherein the first one-way check valve and the second one-way check valve are part of the core mask.

3. The mask of claim 2, wherein the first one-way check valve and the second one-way check valve are positioned vertically on the core mask and the second one-way check valve is located above the first one-way check valve.

4. The mask of claim 2, wherein the first one-way check valve and the second one-way check valve are positioned horizontally on the core mask.

5. The mask of claim 2, wherein a first outer mask covering a portion of the core mask that includes the first one-way check valve forms the first outer filter chamber between the core mask and the first outer mask, and a second outer mask covering a portion of the core mask that includes the second one-way check valve forms the second outer filter chamber between the core mask and the second outer mask.

6. The mask of claim 5, further comprising a space between the first outer mask and the second outer mask.

7. The mask of claim 6, further comprising a covering for the space that forms a third chamber between the first outer mask and the second outer mask in order to maintain a constant shape for the mask, where walls that form the third chamber are airtight to prevent airflow through the third chamber.

8. The mask of claim 1, wherein the first one-way check valve is part of the first outer filter chamber and the second one-way check valve is part of the second outer filter chamber.

9. The mask of claim 8, wherein the first one-way check valve of the first outer filter chamber is used to connect the first outer filter chamber to the core mask, and the second one-way check valve of the second outer filter chamber is used to connect the second outer filter chamber to the core mask.

10. The mask of claim 1, wherein the first one-way check valve closes with an inhale of the person and the second one-way check valve closes with an exhale of the person.

11. A method for separately filtering inhaled and exhaled air using a mask, comprising:
when a person exhales, expelling exhaled air from a core mask to a first outer filter chamber using a first one-way check valve located between the core mask and the first outer filter chamber, wherein the core mask covers the nose and mouth of a person's face and creates an airtight core chamber between the core mask and the person's face and wherein the first outer filter chamber encloses a first volume of air and filters any air that passes from the first outer filter chamber through a wall of the first outer filter chamber; and
when a person inhales, drawing air from a second outer filter chamber to the core mask using a second one-way check valve located between the core mask and the second outer filter chamber, wherein the second outer filter chamber encloses a second volume of air and filters any air that passes into the second outer filter chamber through a wall of the second outer filter chamber.

12. The method of claim 11, wherein the first one-way check valve and the second one-way check valve are part of the core mask.

13. The method of claim 12, wherein the first one-way check valve and the second one-way check valve are positioned vertically on the core mask and the second one-way check valve is located above the first one-way check valve.

14. The method of claim 12, wherein the first one-way check valve and the second one-way check valve are positioned horizontally on the core mask.

15. The method of claim 12, wherein a first outer mask covering a portion of the core mask that includes the first one-way check valve forms the first outer filter chamber between the core mask and the first outer mask, and a second outer mask covering a portion of the core mask that includes the second one-way check valve forms the second outer filter chamber between the core mask and the second outer mask.

16. The method of claim 15, further comprising a space between the first outer mask and the second outer mask.

17. The method of claim 16, further comprising a covering for the space that forms a third chamber between the first outer mask and the second outer mask in order to maintain a constant shape for the mask, where walls that form the third chamber are airtight to prevent airflow through the third chamber.

18. The method of claim 11, wherein the first one-way check valve is part of the first outer filter chamber and the second one-way check valve is part of the second outer filter chamber.

19. The method of claim 18, wherein the first one-way check valve of the first outer filter chamber is used to connect the first outer filter chamber to the core mask, and the second one-way check valve of the second outer filter chamber is used to connect the second outer filter chamber to the core mask.

20. The method of claim 11, wherein the first one-way check valve closes with an inhale of the person and the second one-way check valve closes with an exhale of the person.
